(19) United States
(12) Patent Application Publication
(10) Pub. No.: US 2014/0271095 A1
(43) Pub. Date: Sep. 18, 2014

(54) STAIR TRAVERSING DELIVERY APPARATUS

(71) Applicant: ELL OPERATIONS, INC., Boston, MA (US)

(72) Inventors: Ari UMANS, Cambridge, MA (US); Bee VANG, Wausau, WI (US); Casandra CERI, Cedar Hill, TN (US); Eric HERNANDEZ, Cambridge, MA (US); John REYNOLDS, Cambridge, MA (US); Lia DIGIOVANNA, Massapequa Park, NY (US); Ray TILDEN, Boston, MA (US); Sareena AVADHANY, Milpitas, CA (US); Chris RULLAN, Wexford, PA (US); Greg PUSZKO, Boston, MA (US); Kathryn GRESKOFF, Paoli, PA (US); Lauren LO, Bel Air, MD (US); Matt HOHENBERGER, Boston, MA (US); Michael OLAGUE, San Francisco, CA (US); Molly MCSHANE, Los Altos, CA (US); Veronica BARRERA, Cambridge, MA (US); Wyatt UBELLACKER, Cambridge, MA (US); Chris BENSON, Cambridge, MA (US); Nathan ROBERT, Rockford, IL (US); Tyler WORTMAN, Cambridge, MA (US)

(73) Assignee: ELL OPERATIONS, INC., Boston, MA (US)

(21) Appl. No.: 14/214,292

(22) Filed: Mar. 14, 2014

Related U.S. Application Data
(60) Provisional application No. 61/801,383, filed on Mar. 15, 2013.

(51) Int. Cl. B62B 1/12; B62B 5/02; B62B 5/04

(52) U.S. Cl. CPC B62B 1/12; B62B 5/04; B62B 5/02; B62B 5/025; B62B 5/0404
USPC 414/800; 280/5.22; 280/5.24

(57) ABSTRACT

According to an aspect of the invention, an apparatus for transporting objects comprises a frame for receiving at least one object, at least one handle coupled to the frame, at least one set of wheels coupled to the frame, at least one track coupled to the frame, wherein the track allows movement of the apparatus in addition to the wheels, and at least one brake mechanism coupled to the frame.

### CROSS-REFERENCES TO RELATED APPLICATIONS

The present application claims the benefit of U.S. Provisional Patent Application No. 61/801,383, filed on Mar. 15, 2013, the content of which is hereby incorporated by reference herein in its entirety.

### BACKGROUND OF THE INVENTION

1) Field of the Invention

The invention relates generally to moving equipment and relates more particularly to hand dollies or hand trucks for moving heavy articles or appliances, such as refrigerators, furniture, and inventory up and down stairways.

2) Description of the Related Art

There are various types of dollies and trucks for moving heavy loads. Several difficulties are encountered with these devices, especially when moving one or more heavy objects and articles up and down stairways.

One of these difficulties is that stairs do not enable a smooth surface to effectively roll an apparatus up or down. Another difficulty is in controlling the descent of the heavy objects and articles down the stairs due to high potential energy of the system. Another difficulty lies in the fact that deliverymen do not have an ergonomic handling of the object enabling them to move the apparatus while standing upright, increasing the risk of injury.

### SUMMARY OF THE PRESENT INVENTION

According to an aspect of the invention, an apparatus for transporting objects comprises a frame for receiving at least one object, at least one handle coupled to the frame, at least one set of wheels coupled to the frame, at least one track coupled to the frame, wherein the track allows movement of the apparatus in addition to the wheels; and at least one brake mechanism coupled to the frame.

In certain embodiments, at least one brake mechanism comprises a unidirectional brake. In certain embodiments, the unidirectional brake comprises a first unidirectional clutch that allows a first pulley to rotate independently of the first unidirectional clutch in a first direction and prevents the first pulley from rotating independently of the first unidirectional clutch in a second direction, and a brake that resists movement of the unidirectional clutch. In certain embodiments, the at least one brake mechanism allows variable braking. In certain embodiments, the apparatus comprises a control interface for manually adjusting a braking force. In certain embodiments, the at least one brake mechanism is configured to apply at least one second preset braking force. In certain embodiments, each of the first and the second preset braking force is calibrated for an anticipated load. In certain embodiments, the anticipated load comprises one keg. In certain embodiments, the anticipated load comprises more than one keg. In certain embodiments, the apparatus further comprises a controller to automatically adjust the braking force. In certain embodiments, the braking force automatically adjusts based on at least one of a speed of the apparatus, an incline over which the apparatus is traveling, and a weight of the load. In certain embodiments, the at least one brake mechanism applies a braking force between approximately 120 pounds and 160 pounds. In certain embodiments, the at least one brake mechanism applies a braking force of approximately 140 pounds. In certain embodiments, the at least one brake mechanism comprises at least one of a drum brake, a disc brake, a hydraulic disc brake, a levered brake, fluidic dampers, rotational dampers, an eddy-current brake, or a viscous dampener.

In certain embodiments, the at least one track comprises a tread assembly. In certain embodiments, the at least one tread assembly comprises at least one pulley and a tread that rotates around the at least one pulley. In certain embodiments, an inner surface of the tread has a lower coefficient of friction than an outer surface of the tread. In certain embodiments, an inner surface of the tread is cogged. In certain embodiments, the at least one pulley comprises a mating groove and an inner surface of the tread is a “V” belt that mates with the mating groove. In certain embodiments, the track can be in one of a deployed position and a collapsed position. In certain embodiments, the track comprises a cut channel mechanism to move between a collapsed position and a deployed position. In certain embodiments, the cut channel mechanism comprises a slot to maintain the track in the deployed position. In certain embodiments, the apparatus comprises a locking hinge to maintain the track in the deployed position. In certain embodiments, the apparatus comprises a track pivot configured to apply a force used to pull the track toward the collapsed position. In certain embodiments, the track pivot uses at least one of a torsion spring, an extension spring, and a compression spring. In certain embodiments, the apparatus comprises a track pivot configured to apply a force resistant to the track being in the collapsed position. In certain embodiments, the track pivot uses at least one of a torsion spring, an extension spring, and a compression spring. In certain embodiments, the apparatus comprises a ratchet configured to allow the track to move toward the deployed position in a first mode of operation and inhibit the track from moving toward the collapsed position in the first mode of operation, and to allow the track to move toward the collapsed position in a second mode of operation and inhibit the track from moving toward the deployed position in the second mode of operation.

In certain embodiments, the track can be moved from the collapsed position to the deployed position with a single action. In certain embodiments, the apparatus comprises an actuation handle for moving the track from the collapsed position to the deployed position. In certain embodiments, an angle between the track and the frame is less than approximately 45 degrees when the track is in the deployed position. In certain embodiments, an angle between the track and the frame is less than approximately 30 degrees when the track is in the deployed position. In certain embodiments, an angle between the track and the frame is approximately 20 degrees when the track is in the deployed position.

In certain embodiments, the tracks are recessed in the frame. In certain embodiments, the tracks are configured to lengthen and shorten. In certain embodiments, the apparatus comprises a baseplate coupled to the frame, and the baseplate is configured such that the apparatus can stand substantially upright. In certain embodiments, the apparatus comprises a restraining mechanism coupled to the frame. In certain embodiments, the restraining mechanism is at least one of a claw, a strap, a restraining bar, and a latch. In certain embodiments, the apparatus comprises a second handle, wherein at least one of the first handle and the second handle is modular. In certain embodiments, at least one of the first handle and the second handle is for movement of the apparatus on substantially level surfaces and at least the other of the first handle and the second handle is for movement of the apparatus on substantially sloped surfaces. In certain embodiments, the first handle is configurable to be adjusted in a plurality of positions relative to the frame. In certain embodiments, the first handle can be rotated around a handle pivot. In certain embodiments, the first handle can be extended through a telescoping mechanism. In certain embodiments, the first handle is configured to be adjusted through at least one of manual, hydraulic, mechanical, and electrical actuation. In certain embodiments, the frame is configured for at least one of folding, sliding, and moving the frame to position the first handle.

In certain embodiments, the frame comprises an extruded material. In certain embodiments, the extruded material comprises one of aluminum and magnesium. In certain embodiments, the frame comprises an injected material. In certain embodiments, the injected material comprises an injected glass filled with nylon.

In various embodiments the apparatus can be operated in a variety of manners. In certain embodiments, the apparatus is configured to be operated manually. In certain embodiments, the apparatus is configured to be driven through at least manual control. In certain embodiments, the apparatus is configured to be driven through at least one of electronic, hydraulic, and mechanical control. In certain embodiments, the apparatus comprises a driving mechanism configured to increase the speed of the apparatus. In certain embodiments, the driving mechanism comprises a motor.

In certain embodiments, at least one track comprises at least one of a roller, a multi-directional skid bar, a bi-directional skid bar, and a uni-directional skid bar. In certain embodiments, the at least one track comprises a support surface. In certain embodiments, the support surface comprises at least one of aluminum, plastic, and steel. In certain embodiments, the apparatus is configured to determine braking speed based on the acceleration of the apparatus. In certain embodiments, the at least one brake mechanism is located at the at least one of a first end and a second end of the track. In certain embodiments, the at least one brake mechanism provides passive braking. In certain embodiments, the at least one brake mechanism provides active braking. In certain embodiments, at least one tread assembly comprises a tensioning mechanism, wherein the tensioning mechanism adjusts the tension of the tread between the at least one pulley and a second pulley. In certain embodiments, the tensioning mechanism comprises at least one of a constant force spring, a screw, and a bolt.

In certain embodiments, the apparatus is configured to assist in moving the object up stairs. In certain embodiments, the apparatus comprises at least one of a mechanical device and an electrical device to provide at least one of torque and force. In certain embodiments, the mechanical or electrical device comprises at least one of a motor, a hydraulic system, and a mechanical system. In certain embodiments, the apparatus is configured to receive at least one keg.

In certain embodiments, the apparatus comprises a damping mechanism. In certain embodiments, the damping mechanism comprises at least one of a collapsing slide, a chute, a hydraulic shock absorber, a coilover damper, and a gas damper. In certain embodiments, the apparatus comprises a first fluidic damper to absorb a shock of the apparatus. In certain embodiments, the apparatus comprises a second fluidic damper, wherein the first and second fluidic dampers are offset.

According to a further aspect of the invention, a method of transporting an object is described, which comprises providing a transport apparatus comprising: a frame for receiving at least one object; at least one handle coupled to the frame; at least one set of wheels coupled to the frame; at least one track coupled to the frame; and at least one brake mechanism coupled to the frame. According to this aspect of the invention, the method further comprises moving the frame on the at least one set of wheels when the frame is on a substantially level surface, moving the frame on the track when the frame is on a sloped surface, and utilizing the brake mechanism to decrease the speed of movement of the frame on a sloped surface.

In certain embodiments, the method comprises adjusting a braking force applied by the brake mechanism. In certain embodiments of the invention, a braking force is adjusted manually. In certain embodiments, the method comprises applying at least one preset braking force. In certain embodiments, each preset braking force is calibrated for an anticipated load. In certain embodiments, the anticipated load comprises one keg. In certain embodiments, the anticipated load comprises more than one keg. In certain embodiments, the method comprises automatically adjusting a braking force. In certain embodiments, the braking force is automatically adjusted based on at least one of a speed of the apparatus, an incline over which the apparatus is traveling, and a weight of the load. In certain embodiments, the method comprises using a unidirectional brake to decrease the speed of movement. In certain embodiments, the method comprises applying two or more braking forces. In certain embodiments, the method comprises applying a braking force between approximately 120 pounds and 160 pounds. In certain embodiments, the method comprises applying a braking force of approximately 140 pounds. In certain embodiments, the method comprises applying a braking force with at least one of a drum brake, a disc brake, a hydraulic disc brake, a levered brake, fluidic dampers, rotational dampers, an eddy-current brake, and a viscous dampener.

In certain embodiments, the method comprises rotating a tread around at least one pulley of the track. In certain embodiments, the method comprises rotating a tread with an inner surface that has a lower coefficient of friction than its outer surface around at least one pulley of the track. In certain embodiments, the method comprises mating a cogged inner surface of the tread with the at least one pulley. In certain embodiments, the method comprises mating a “V” belt surface of the tread with a mating groove of the at least one pulley.

In certain embodiments, the method comprises deploying the track for use on a sloped surface. In certain embodiments, the method comprises securing the track in a deployed position. In certain embodiments, the method comprises securing the track in the deployed position using at least one of a cut channel mechanism, a locking hinge, a track pivot, and a ratchet. In certain embodiments, the deploying step is performed with a single action. In certain embodiments, the deploying step is performed using an actuation handle. In certain embodiments, an angle between the track and the frame is less than approximately 45 degrees when the track is in the deployed position. In certain embodiments, the angle between the track and the frame is less than approximately 30 degrees when the track is in the deployed position. In certain embodiments, the angle between the track and the frame is approximately 20 degrees when the track is in the deployed position.

In certain embodiments, the method comprises collapsing the track. In certain embodiments, the method comprises securing the track in a collapsed position. In certain embodiments, the method comprises securing the track in the collapsed position using at least one of a cut channel mechanism, a locking hinge, a track pivot, and a ratchet. In certain embodiments, the collapsing step is performed with a single action. In certain embodiments, the collapsing step is performed using an actuation handle. In certain embodiments, the method comprises at least one of lengthening or shortening the tracks. In certain embodiments, the method comprises further providing a track recessed in the frame.

In certain embodiments, the method comprises restraining the object using a restraining mechanism. In certain embodiments, the restraining mechanism comprises at least one of a claw, a strap, a restraining bar, and a latch.

In certain embodiments, the method comprises providing at least one of a modular first handle and a modular second handle, and replacing at least one of the first and second handles. In certain embodiments, the method comprises the step of extending the first handle by at least one of rotating the first handle around a handle pivot and telescoping the first handle. In certain embodiments, the method comprises extending the first handle using at least one of manual, hydraulic, mechanical, and electrical actuation. In certain embodiments, the method comprises at least one of folding, sliding, and moving the frame to extend the first handle.

In various embodiments, the method comprises operating the apparatus in a variety of manners. In certain embodiments, the method comprises operating the transport apparatus manually. In certain embodiments, the method comprises driving the transport apparatus through at least manual control. In certain embodiments, the method comprises driving the transport apparatus through at least one of electronic, hydraulic, and mechanical control. In certain embodiments, the method comprises increasing the speed of the transport apparatus. In certain embodiments, the method comprises driving the apparatus with a motor.

In certain embodiments, the method comprises determining the braking force relative to the acceleration of the transport apparatus. In certain embodiments, the method comprises using passive braking. In certain embodiments, the method comprises using active braking.

In certain embodiments, the method comprises tensioning the track using a tensioning mechanism. In certain embodiments, the method comprises transporting at least one keg. In certain embodiments, the sloped surface comprises stairs. In certain embodiments, the method comprises positioning the transport apparatus such that there are at least two points of contact between the track and the stairs.

In certain embodiments, the method comprises using a damping mechanism to absorb energy. In certain embodiments, the damping mechanism is at least one of a collapsing slide, a chute, a hydraulic shock absorber, a coilover damper, and a gas damper. In certain embodiments, the method comprises using a first fluidic damper to absorb a shock of the apparatus. In certain embodiments, the method comprises using a second fluidic damper, wherein the first and second fluidic dampers are offset.

### BRIEF DESCRIPTION OF THE DRAWINGS

FIG. 1 is an isometric view, showing an embodiment of the present invention.

FIG. 2 is a profile view of the right side of an embodiment of the invention, showing the baseplate and the profile of the treads and wheels with the tread assembly in a collapsed state.

FIG. 3 is a profile view of the right side of an embodiment of the invention, showing the baseplate and the profile of the treads and wheels with the tread assembly in a deployed state.

FIG. 4 is a cross-sectional view of an embodiment of a speed control mechanism.

FIG. 5 is an isometric view of an embodiment of tread assembly and locking mechanism in a collapsed state.

FIG. 6 is an isometric view of an embodiment of tread assembly and locking mechanism in a deployed state.

FIG. 7 is a perspective view, showing an embodiment of use on a sloped surface with a deployed tread assembly.

FIG. 8A is a side profile view of the left side of an embodiment of the invention.

FIG. 8B is an isometric view of an embodiment of the invention.

FIG. 9 is a perspective view, showing an embodiment of the present invention.

FIG. 10 is a profile view of the right side of an embodiment of the invention, showing the baseplate and the profile of the treads and wheels.

FIG. 11 is a perspective view of one embodiment of the treads and housing that enables damping and/or braking.

FIG. 12 is a perspective view of one embodiment of a handle locking mechanism.

FIG. 13 is a perspective view of one embodiment of the handle in a collapsed position.

FIG. 14 is a perspective view of one embodiment of the handle in an extended position.

FIG. 15 is a perspective view, showing an exemplary use on a level surface.

FIG. 16 is a perspective view, showing an exemplary use on an uneven surface.

FIG. 17 is a perspective view, showing an embodiment with recessed treads and an extendible handle.

FIG. 18 is a profile view, showing an embodiment with fluidic dampers.

REFERENCE NUMERALS IN THE DRAWINGS

| | |
|---|---|
| 101 | Rigid frame |
| 102 | Independently rotating wheels |
| 103 | Baseplate |
| 104 | Handle for level surfaces |
| 105 | Handle for sloped surfaces |
| 106 | Tread assembly |
| 107 | Restraining Mechanism |
| 108 | Tread assembly pivot |
| 301 | Treads |
| 302 | Support surface |
| 401 | Unidirectional clutch |
| 402 | Brake pad |
| 403 | Pulley |
| 404 | Axle |
| 405 | Nut |
| 406 | Spring |
| 501 | Tensioning mechanism |
| 502 | Speed control mechanism |
| 503 | Locking groove |
| 601 | Tread guide |
| 602 | Actuation handle |
| 603 | Locking mechanism for tread |
| | assembly |
| 801 | Locking hinge |
| 901 | Rigid frame |
| 902 | Independently rotating wheels |
| 903 | Baseplate |
| 904 | Intermediate handle |
| 905 | Extendible handle |
| 906 | Restraining mechanism |
| 907 | Locking/Unlocking mechanism |
| 908 | Housing for wheels |
| 1101 | Speed control mechanism |
| 1102 | Energy dissipation housing |
| 1201 | Extendible handle locking |
| | mechanism |
| 1301 | Handle pivot |
| 1401 | Brake control lever |
| 1801 | Fluidic dampers |
| 1802 | Legs |
| 1803 | Hydraulic mechanism |

### DETAILED DESCRIPTION OF THE INVENTION

As set forth in detail below, an aspect of the present invention relates to a mechanical system to be used as a delivery aid for moving loads. An embodiment of the invention may be configured to enable traversal of both level and uneven surfaces. In some embodiments, these uneven surfaces include stairs. In other embodiments, these level surfaces include ramps. In some embodiments, the delivery apparatus is configured to be operated manually. In other non-limiting embodiments, the delivery apparatus can be driven electronically, hydraulically, or mechanically. In yet other embodiments, the delivery apparatus is configured to be driven through any combination of manual, electronic, hydraulic, or mechanical control.

In some embodiments, the delivery apparatus includes a rigid frame with a handle and two freely rotating wheels on two independent axles. In certain embodiments the delivery apparatus includes a tread assembly coupled to the frame on a pivot. In certain embodiments the pivot of the tread assembly enables the rotation of the treads relative to the frame at an angle favorable to the ergonomic operation of the apparatus. In other embodiments the frame may house the recessed treads. In still other embodiments the handle rotates relative to the frame at an angle favorable to the ergonomic operation of the apparatus. In certain embodiments, the treads provide a minimum of two points of contact with the stair edges enabling the smooth traversal of the system over the recesses in stairs. In some embodiments, the orientation of the unit is changed by the user depending on whether or not the surface is level, such as the floor or ramp, or uneven, such as stairs.

In another embodiment, a system to control the ascent or descent speed of the delivery apparatus is provided within the tread assembly and is coupled to the rotating wheels and/or the treads. In certain non-limiting embodiments, the system to control the ascent or descent speed of the mechanical invention includes brakes. In other non-limiting embodiments, the ascent or descent speed of the delivery apparatus is controlled by fluidic dampers or rotational dampers. In further embodiments, the descent or ascent speed is controlled through friction. In another embodiment, the speed-controlling device can include components (such as a motor) that would increase the speed of the device or provide further assistance to the user when pushing the delivery apparatus up a flight of stairs. In yet another embodiment, the speed-controlling device can include components that can increase or decrease the speed of the delivery apparatus.

In another embodiment, the delivery apparatus includes an extendible handle. The handle can be extended by folding out around a pivot point. In other non-limiting embodiments, the handle slides out to a longer length. In certain embodiments, the handle is modular and may be replaced by handles of varying shapes and sizes. In certain other non-limiting embodiments the frame folds, slides, and/or moves to provide a grip favorable to ergonomic use on sloped surfaces. In some embodiments, the mechanism by which the handle is extended can be manually controlled. In other non-limiting embodiments, the mechanism by which the handle is extended can be actuated hydraulically, mechanically, or electrically or through a combination of the same. In further embodiments, the actuation mechanism is a combination of manual and hydraulic, mechanical, or electrical actuation. The delivery apparatus also includes a mechanism for securing the load it is transporting. In certain non-limiting embodiments, the securing mechanism comprises one or more claws, straps, restraining bars and/or latches. In certain embodiments, the apparatus has a compact design appropriate for delivering objects such as kegs, boxes, and furniture. In certain embodiments, the apparatus is durable enough for repeated use moving objects over a variety of surfaces.

In certain embodiments, the apparatus advantageously reduces the force an operator applies on the load and the force the load applies on the operator. In certain embodiments, the apparatus reduces the load through braking. Additionally, in certain embodiments, the apparatus advantageously glides down stairs enabling smooth operation with more control and less jarring. Furthermore, in certain embodiments, there is reduced wear and tear on the apparatus and the infrastructure, such as stairs, ramps, loading docks, sidewalks, and other surfaces.

FIG. 1 shows a perspective view of an embodiment of the present invention in an assembled state. The rigid frame 101 includes the baseplate 103, independently rotating wheels 102, the handle for level surfaces 104, the handle for sloped surfaces 105, the tread assembly 106, and the restraining mechanism 107. In some embodiments, the baseplate 103 is configured to be fixed directly to the frame and is geometrically oriented to enable the apparatus to stand upright. In some embodiments the weight of the apparatus is balanced such that it can stand upright without external support. The independently rotating wheels 102 are geometrically positioned to enable the frame 101 to be tilted back to function as a lever arm to provide sufficient mechanical advantage to enable the user to have control over the load distributed over the baseplate 103. The load is secured to the delivery apparatus using a restraining mechanism 107. In certain non-limiting embodiments, the restraining mechanism 107 consists of one or more claws, straps, restraining bars and/or latches. In some embodiments the tread assembly 106 is fixed to the frame with the tread assembly pivot 108, enabling the tread assembly 106 to collapse and deploy as necessary.

FIG. 2 shows a profile view of the right side of an embodiment of the invention, showing the baseplate 103 and the profile of the tread assembly 106 in a collapsed state and independently rotating wheels 102. The apparatus is designed to traverse sloped or uneven surfaces, such as stairways, through the use of the collapsible tread assembly 106. In certain embodiments the tread assembly 106 can be deployed around the tread assembly pivot 108.

FIG. 3 shows a profile view of the right side of an embodiment of the invention, showing the baseplate 103 and the profile of the tread assembly 106 in a deployed state and independently rotating wheels 102. In certain embodiments the tread assembly 106 is deployed. On sloped surfaces such as stairs the delivery apparatus is pivoted around the independently rotating wheels 102 such that the treads 301 in the tread assembly 106 are resting against the stairs or sloped surface. The treads 301 are resting against a supported surface within the tread assembly 106 providing adequate normal force to enable the apparatus to descend down stairs. In certain embodiments the angle to which the treads 301 deploy, relative to the frame 101, is designed to provide the most ergonomic hold for users, enabling improved upright positioning and continuous operation, minimizing the risk of injury.

In certain embodiments, the angle between the tread assembly 106 and the frame 101 is less than approximately 45 degrees when the track is in the deployed position. An angle of less than approximately 45 degrees may be advantageous in certain embodiments for moving lighter objects. In certain embodiments, the angle between the tread assembly 106 and the frame 101 is less than approximately 30 degrees when the track is in the deployed position. An angle of less than 30 degrees may be advantageous in certain embodiments for lifting heavier loads. In certain embodiments, the angle between the tread assembly 106 and the frame 101 is approximately 20 degrees when the track is in the deployed position. An angle of approximately 20 degrees may be advantageous in certain embodiments for lifting even heavier loads. In certain embodiments the handle for sloped surfaces 105 is fixed to an ergonomic height. The angle of rotation of the tread assembly 106 relative to the frame 101 and the handle for sloped surfaces 105 is fixed such that on sloped surfaces, the user of the apparatus can stand substantially upright and lift ergonomically, reducing the risk of injury.

In certain embodiments the frame 101 is made from extruded aluminum or magnesium. In other non-limiting embodiments the frame 101 is made of injected glass filled nylon. In still other non-limiting embodiments the frame 101 is composed of any material or alloy providing sufficient rigidity to withstand loads transported with the apparatus. In certain embodiments, the inner surface of the tread 301 and/or a support surface of tread assembly 106 is made from a material with a low coefficient of friction, such as polyoxymethylene, to reduce friction between the tread and the frame in order to reduce wear.

FIG. 5 is an isometric view of an embodiment of the tread assembly 106. In some embodiments, the treads 301 extend across a significant portion of the delivery apparatus. For example, in one embodiment, treads 301 extend at least to the position of the axle of the independently rotating wheel 102, and are tangent to the outer surface of the wheel. Minimizing space between the treads 301 and wheel minimizes jarring and uneven motion that otherwise occurs when there is space between the treads 301 and wheels such that the wheels contact the stairs during traversal. In some embodiments, the treads 301 are offset from the frame 101 such that they are parallel to a line tangent to the independently rotating wheels 102. In other non-limiting embodiments, the treads 301 are affixed to the frame 101. In some embodiments, there is one tread 301. In other embodiments, there is more than one tread 301 (e.g., two or three treads or more). In certain embodiments, the treads 301 provide a minimum of two points of contact with the stair edges enabling the traversal of the system over the recesses in stairs. One of ordinary skill in the art would recognize that an embodiment of the invention could include more than three treads and/or could utilize treads that provide less or more than two points of contact with the surface on which the embodiment is traversing. In certain embodiments the tread assembly 106 is made from timing belts or cog belts. In certain embodiments the tread assembly is a v-belt. In other non-limiting embodiments rollers, multi-directional skid bars, bi-directional skid bars, or uni-directional skid bars can provide the same functionality as the tread assembly 106. In other embodiments, the treads 301 can extend across a less significant portion of the delivery apparatus.

As additionally shown in FIG. 5, in an embodiment, the treads 301 are positioned over an assembly of two or more rollers or pulleys 403 set on axles 404 fixed to the frame. The treads are comprised of wear-resistant and flexible material tensioned over the rollers or pulleys 403. When the treads 301 contact steps, they are tensioned over a support surface 302 that is coupled to the back of the frame 101. The support surface 302 provides a normal force when the steps push against the treads 301, but still allows the treads to slide upon it. In some non-limiting embodiments the support surface is aluminum, plastic, or steel. One of ordinary skill in the art would recognize that the tread 301 configurations discussed above are just a few of the many types of track-based configurations that can traverse uneven surfaces, such as stairs. For example, depending on the surface being traversed, one of ordinary skill in the art might utilize a chain-link configuration. Additionally, one of ordinary skill in the art might utilize a smooth material with a low coefficient of friction.

FIG. 4, discussed further below, shows a cross sectional view of a speed control mechanism 502 providing unidirectional braking according to an embodiment of the invention.

As further shown in FIG. 5, in certain embodiments, the treads 301 are part of the tread assembly 106. In certain embodiments there is variable braking on the treads 301 increasing relative to the velocity of the apparatus. In certain embodiments, variable braking can be adjusted manually. In certain embodiments, the apparatus allows a user to easily adjust the braking by selecting a preset braking setting. In certain embodiments, the apparatus provides multiple preset braking settings that allow a user to calibrate the braking for different loads, such as one keg, two kegs, a light box, or heavy furniture. In certain embodiments, the apparatus includes a control interface such as a switch, a dial, or other mechanism to allow a user to adjust the braking settings. In certain embodiments, the apparatus includes a control interface configured for a user to specify a particular braking force. In certain embodiments, the apparatus comprises a controller that automatically adjusts the variable braking based on factors such as the speed of the apparatus, the incline over which the apparatus is traveling, and the weight of the load. In certain embodiments, the apparatus provides a combination of manually adjusted and automatically adjusted variable braking. In other embodiments the braking could be increased or decreased relative to the acceleration of the apparatus. In certain non-limiting embodiments, the brakes are drum brakes, disc brakes, hydraulic disc brakes, and/or levered brakes. In other non-limiting embodiments, energy is removed by fluidic dampers or rotational dampers. In further embodiments, the descent or ascent speed is controlled through friction. In certain embodiments, the braking can be passive. In other embodiments, the braking can be active. In certain embodiments the active braking can be anti-lock braking. In certain non-limiting embodiments braking can be provided by the speed control mechanism 502 through eddy-current braking, and/or viscous damping. In another embodiment, the speed-controlling device can include components (such as a motor) that would increase the speed of the device or provide further assistance to the user when pushing the delivery apparatus up or down a flight of stairs. In yet another embodiment, the speed-controlling mechanism 502 can include components that can increase or decrease the speed of the delivery apparatus. In certain embodiments the speed control mechanism 502 is located at the top of the tread assembly 106, at the bottom of the tread assembly 106, or at both the top and bottom of the tread assembly 106. In certain non-limiting embodiments the speed control mechanism 502 can be a combination of speed control for motion both up and down the stairs. The speed control mechanism 502 can slow the descent of the apparatus passively without user actions and/or actively with user action. Likewise, while traversing up the stairs, the apparatus can provide torque on the treads 301 or independent wheels 102 to assist the user in moving the delivery apparatus up the stairs.

As additionally depicted in FIG. 5, in certain embodiments tread assembly 106 is an assembly of two or more speed control mechanisms 502 set on axles fixed to the tread assembly 106 with wear-resistant flexible material tensioned between them. The treads 301 slide over the speed control mechanism 502 and are tensioned continuously using the tensioning mechanism 501. In some embodiments the tensioning mechanism 501 applies a force moving the speed control mechanism 502 until the force of the tensioning mechanism 501 is equal to the tension in the treads 301. This tension on the treads prevents the treads from slipping or disengaging due to wear and inelastic expansion of the tread 301 material. In some embodiments the tensioning mechanism 501 is a set of constant force springs. In other non-limiting embodiments the tension is set manually using a screw or bolts on the axle. In certain embodiments, the tread tensioning mechanism includes a screw that when turned increases the distance between the pulleys, which can tension the treads to prevent them from becoming loose due to inelastic deformation of the tread material.

FIG. 4 shows a cross sectional view of a speed control mechanism 502 providing unidirectional braking according to an embodiment of the invention. The speed control mechanism 502 includes a unidirectional clutch 401 and brake pad 402. The pulley 403 rotates around the axle 404 and the pulley 403 interfaces with the treads 301. The unidirectional clutch 401 allows the pulley 403 to rotate independently of the unidirectional clutch 401 in a first direction and prevents the pulley 403 from rotating independently of the unidirectional clutch 401 in a second direction. The brake pad 402 resists the movement of the unidirectional clutch 401, and thus applies braking in the second direction, while allowing the pulley to freely rotate in the first direction. The spring 406 and the nut 405 can be used to adjust the applied braking force. In certain embodiments, the nut 405 can be rotated to increase or decrease the braking force by transferring force via the spring 406 to the brake pad 402.

FIG. 6 shows that in certain embodiments the tread assembly 106 includes treads 301 and an assembly of two or more speed control mechanisms 502 set on axles 404 and fixed to the tread assembly 106 with wear-resistant flexible material tensioned over them in the apparatus' deployed state. In certain embodiments the treads 301 can be deployed using the actuation handle 602. A force applied to the actuation handle 602 pivots the tread assembly 106 around the tread assembly pivot 108. In certain embodiments the tread assembly pivot 108 can continuously apply a force keeping the treads in a collapsed state. In certain non-limiting embodiments the tread assembly pivot 108 can continuously apply such a force using a series of torsion springs. In other non-limiting embodiments the tread assembly pivot 108 can continuously apply such a force using a series of extension springs and/or compression springs. In certain embodiments the force pivots the tread assembly 106 moving the locking mechanism for the tread assembly 603 along the tread guide 601. In certain embodiments, the tread guide 601 is a channel. The treads 301 lock into the deployed state when the locking mechanism for the tread assembly 603 slides into the locking groove 503 in the tread guide 601. In other embodiments the tread assembly 106 is recessed in the frame and extended through a four bar linkage using a force applied at the actuation handle 602. In other non-limiting embodiments the treads 301 are deployed by a slot extension mechanism, rails and guides, and/or a pivot with constrained rotation to align the tread assembly 106 such that angle between the handle for sloped surfaces 105 and the tread assembly 106 is ergonomically designed for the user. In certain embodiments, the tread assembly 106 is locked in a deployed position using a locking hinge and/or a ratcheting mechanism. In certain embodiments, in one mode of operation the ratchet allows the tread assembly 106 to move toward the collapsed position, but not toward the deployed position, such that the tread assembly can be locked in the collapsed position, and another mode of operation, the ratchet allows the tread assembly 106 to move toward the deployed position, but not toward the collapsed position, such that the tread assembly 106 can be locked in the deployed position.

FIG. 7, discussed further below, is a perspective view, showing an embodiment of the apparatus' use on a sloped surface or uneven surface such as stairs according to an aspect of the invention.

FIGS. 8A and 8B show an example of a non-limiting embodiment using a locking hinge 801. The locking hinge 801 is coupled between the tread assembly 106 and the frame 101. FIG. 8A shows the locking hinge 801 in an unlocked position. FIG. 8B shows the locking hinge 801 in a locked position, where the locking hinge maintains the tread assembly 106 in a deployed position. The locking hinge 801 can be unlocked by applying a force to the locking hinge 801 to move it from the locked position to the unlocked position.

FIG. 7 is a perspective view, showing an embodiment of the apparatus' use on a sloped surface or uneven surface such as stairs according to an aspect of the invention. In an exemplary method of use, the user pulls back on the apparatus using the handle for level surfaces 104 to lower the apparatus to approximately waist height. The user pulls on the actuation handle 602 pivoting the tread assembly 106 around the tread assembly pivot 108 until the tread assembly 106 locks into place in the groove in the tread guide 602. The user then rolls the apparatus over the first step of the stairwell, holding the handle for level surfaces 104. The treads 301 engage the lip of the first stair and enable the apparatus to begin to traverse down the stairs. The user transitions his grip from handle for level surfaces 104 to handle for sloped surfaces 105. In some embodiments the handle for sloped surfaces 105 allows the user to maintain a more ergonomic grip, while providing a longer lever arm on the apparatus to control the apparatus and the fixed load. The user allows the weight of the load to pull the apparatus down the stairs. In some embodiments the speed of the traversal is controlled using the speed control mechanism 502. The user can transition to holding the apparatus at the handle for level surfaces 104 when the apparatus is returned to a level surface. This enables the independent wheels 102 to engage on level surfaces to enable the apparatus to rotate with the user on or around tight bends. In an embodiment the apparatus is lifted to its upright state at the end of the staircase and the tread assembly is collapsed. The collapsed state enables the user to move the compact delivery apparatus in tight spaces.

In an embodiment, the user will carry or roll the apparatus up stairs using the reverse of the method described. In some embodiments the apparatus assists in moving the load up the stairs using a mechanical or electrical devices to provide torque and/or force. In some embodiments the apparatus involves one or more motors, a hydraulic system using, for example, energy stored in a pressurized container, or a mechanical system including springs, flywheels, or other appropriate methods of storing energy.

In an embodiment shown in shown in FIG. 7, the apparatus includes moving components including the independently moving wheels 102 and the tread assembly 106. In an embodiment the independently rotating wheels 102 rotate on separate axles. In other non-limiting embodiments the independently rotating wheels 102 are on the same axle. In one embodiment the user applies a torque about the independently rotating wheels by pulling down and back on the handle for level surfaces 104. In this embodiment the handle for level surfaces 104 remains rigid relative to the rest of the frame. The tread assembly 106 pivots relative to the frame 101. In some embodiments the locking mechanism for the tread assembly 603 locks the tread assembly in place at the latch in the tread guide 501, fixing the angle between the frame 101 and the tread assembly 106. In other embodiments the angle is locked using a rotation locking mechanism fixed at the pivot. The treads 301 engage and grip the first lip of the stairs remaining static relative to the step and slide relative to the frame of the delivery apparatus due to the acceleration provided by gravity and the user. In one embodiment the treads 301 are tensioned between two or more speed control mechanisms 402, which rotate around an axle set into the frame. In some embodiments the axle set into the frame is damped using a speed control mechanism 502 such as, but not limited to, a rotational damper or torsional damper. In other embodiments the motion of the axle is controlled using a damper known to those skilled in the art. The user guides the apparatus with force applied at the handle for sloped surfaces 105 with a mechanical advantage given through the lever arm defined by the length of the handle for sloped surfaces 105. The treads 301 contact two or more stair lips at any given time providing continuous motion down the stairs. The acceleration of the treads 301 is limited by the speed control mechanism 502. In certain embodiments the independently rotating wheels 102 act as a bumper, or appropriate damping mechanism, for the apparatus as it traverses down the stairs. In one embodiment, upon reaching a level surface such as a landing on the stairs before a bend, or at the bottom of the stairs, the user applies an upward force on the handle for sloped surfaces 105. The upward force disengages the treads 301 from the lips of the stairs as the apparatus pivots around the independently rotating wheels. In the embodiment the user changes his grip to the handle for level surfaces 104 and rotates the apparatus on the level surface and drive it further down a flight of stairs using the same method as described above. The tread assembly 106 can be collapsed against the frame by unlocking the locking mechanism for the tread assembly 603.

FIGS. 9 through 17 depict alternative embodiments. As explained below, in certain embodiments shown in FIGS. 9 through 17, the treads are recessed in the frame. Additionally, in certain embodiments shown in FIGS. 9 through 17, a handle is configurable to be adjusted in a plurality of positions relative to the frame. Also, certain embodiments shown in FIGS. 9 through 17 include other features as described below.

FIG. 9 shows a perspective view of an embodiment of the present invention. The rigid frame 901 includes the baseplate 903, independently rotating wheels 902, intermediate handle 904, and the wheel housing 908 for the independently rotating wheels 902. In some embodiments, the baseplate 903 is configured to be fixed directly to the frame and is geometrically oriented to enable the apparatus to stand upright. The independently rotating wheels 902 may be on independent axles set into the wheel housing 908. In certain non-limiting embodiments, the wheel housings 908 are designed to prevent debris, articles of clothing, or the user's body from being caught. The independently rotating wheels 902 are geometrically positioned to enable the frame 901 to be tilted back on a lever arm (not shown) that provides sufficient mechanical advantage to provide the user with control over the load distributed over the baseplate 903. The load is secured to the delivery apparatus using a restraining mechanism 906. In certain non-limiting embodiments, the mechanism comprises one or more claws, straps, restraining bars and/or latches.

The embodiment shown in FIG. 9 is designed to traverse sloped or uneven surfaces, such as stairways, through a change in orientation. The apparatus pivots around the independently rotating wheels 902 to such a point where the frame 901 is resting on the surface. In some embodiments, this transition is made easier using the intermediate handle 904 and the extendible handle 905. In some embodiments the extendible handle 905 is used as the handle for the upright use of the apparatus in its collapsed state. In other non-limiting embodiments, the intermediate handle enables the use of the apparatus in its upright state. The locking/unlocking mechanism 907 is used to transition the extendible handle 905 from its extended to its collapsed state and from its collapsed to its extended state. The locking/unlocking mechanism 907 secures the handle such that it is capable of translating loads applied by the user to the apparatus. In some embodiments, the extendible handle 905 can be extended by folding out around a pivot point. The extendable handle 905 comprises fixed frame handles and a telescoping section. In one embodiment, the telescoping section slides out to a longer length from its collapsed state. In another embodiment, the cross-section of the telescoping section is larger than the cross-section of the fixed frame handles at the end. The intermediate handle 904 enables the user to have a transitional grip from the upright state of the apparatus to the horizontal state. In some embodiments, the orientation of the unit is changed by the user depending on whether or not the surface is level, such as the floor, or sloped and uneven, such as stairs. In other embodiments, the orientation of the apparatus is fixed.

FIG. 10 shows a profile view of an embodiment of the independently rotating wheel 902, the baseplate 903 and the treads 1001. In some embodiments, the treads 1001 extend across a significant portion of the delivery apparatus. For example, in one embodiment, treads 1001 extend at least to the position of the axel of the independently rotating wheel 902, and are preferably tangent to the outer surface of the wheel. By minimizing space between the treads and wheel, the configuration minimizes jarring and uneven motion that otherwise occurs when there is space between the treads and wheels such that the wheels contact the stairs during traversal. In some embodiments, the treads 1001 are offset from the frame such that they are parallel to a line tangent to the independently rotating wheels 902. In certain non-limiting embodiments, the treads 1001 are recessed in the frame 101. In other non-limiting embodiments, the treads 1001 are affixed to the frame. In some embodiments, there is one tread. In other embodiments, there is more than one tread (e.g., two or three treads). In certain embodiments, the treads 1001 provide a minimum of three points of contact with the stair edges enabling the traversal of the system over the recesses in stairs. One of ordinary skill in the art would recognize that an embodiment of the invention could include more than three treads and/or could utilize treads that provide fewer than, or more than, three points of contact with the surface being traversed.

In one embodiment, the treads 1001 are positioned over an assembly of two or more rollers set on axles fixed to the frame. The treads may comprise wear-resistant flexible material tensioned over the rollers. When the treads contact the steps, they are tensioned over a support surface that is coupled to the back of the frame. The support surface provides a normal force when the steps push against the treads, but still allows the treads to slide upon it. In some non-limiting embodiments the support surface is aluminum, plastic, or steel. One of ordinary skill in the art would recognize that the tread configuration discussed above is just one of many types of track-based configurations that can traverse uneven surfaces, such as stairs. For example, depending on the surface being traversed, one of ordinary skill in the art might utilize a chain-link configuration. In certain embodiments, the treads 1001 can be lengthened or shortened. In certain non-limiting embodiments, the length of the treads can be increased or decreased with a tensioning mechanism. In certain non-limiting embodiments, the tread is modular and tread extensions can be added or removed to adjust the length of the tread. In certain embodiments, pulleys can be added or removed to adjust the length of the tread.

FIG. 11 is a perspective view of an embodiment of the treads 1001 and housing 1102 that enables dampening and/or braking. In some embodiments, the housing 1102 protects the speed control mechanism 1101 from debris and exposure to the elements. In other non-limiting embodiments, the housing 1102 protects the user of the apparatus from injury. In some embodiments, the speed control mechanism 1101 provides braking energy to the system. In certain non-limiting embodiments, the brakes are drum brakes, disc brakes, hydraulic disc brakes, and/or levered brakes. In other non-limiting embodiments, energy is removed by fluidic dampers or rotational dampers. In certain non-limiting embodiments the speed control mechanism can be a combination of speed control for motion both up and down the stairs. The speed control mechanism 1101 can slow the descent of the apparatus passively and/or actively with user input. Likewise, while traversing up the stairs, the apparatus can provide assisted torque on the treads 1001 or independent wheels 902 to assist the user in moving the delivery apparatus up the stairs.

FIG. 12 is a perspective view of an embodiment of the handle locking mechanism 1201 which secures the extendible handle 905 in its collapsed and extended state. In some embodiments, the locking mechanism 1201 is a pin, latch, strap, restraining bar, or slidable gusset that locks the handle in place in its extended position. In some embodiments, the intermediate handle 904 is on the exterior of the frame 901. In other non-limiting embodiments, the intermediate handle 904 is on the interior of the frame 901.

FIG. 13 is a perspective view of an embodiment of the extendible handle 905 illustrating its collapsed state. In one embodiment the apparatus can be used to traverse level surfaces, enabling the transport of loads set on the baseplate 903 and secured with the latching mechanism 906. In some embodiments, the operator, upon approaching a stairwell or sloped surface, can set the delivery apparatus down and release the extendable handle 905 using the locking/unlocking mechanism 907 to enable it to move to its extended state. In some embodiments, the extendible handle 905 for use on sloped surfaces can be extended through rotation around the handle pivot 1301. In other non-limiting embodiments, the extendible handle 905 slides out to a longer length from its collapsed state. In further non-limiting embodiments, the extendible handle 905 extends out to a longer length using a telescoping design where the extended handle cross-section is larger in size than the fixed frame handle cross-section. FIG. 13 illustrates one embodiment of the extendible handle 905, which can be pivoted to its fully extended position described in FIG. 14.

FIG. 14 is a perspective view of an embodiment of the extendible handle 905 in its extended state. The extendible handle 905 provides leverage and control over the apparatus and the secured load, such as when the apparatus is on an uneven surface as shown in FIG. 16. Furthermore, the extendable handle provides the leverage necessary to remove the user from the load while descending down a sloped surface. Lastly, the extendable handle is long enough to provide a larger lever arm by which the user can apply a force to lift and maneuver the load while on a sloped surface. In an embodiment, the user will grasp the intermediate handle 904 while lowering the delivery apparatus before using the extendible handle 905 to control the apparatus on sloped and uneven surfaces, such as stairs. In some embodiments, the brake control lever 1401 enables the user to actuate the speed control mechanism 1101. In other non-limiting embodiments the speed control mechanism 1101 is passive, requiring no input from the user.

In other embodiments the extendible handle 902 is part of the frame 901 and folds or collapses upon itself using a handle pivot 1301. In other non-limiting embodiments the handle collapses by use of a four bar linkage (not shown). In some embodiments the frame 901 is of a custom extrusion with built-in rails to guide the extendible handle 905 to their respective extended and collapsed positions.

In some embodiments the extendible handle 905 is locked into position with the handle locking mechanism 907, which secures the extendible handle 905 in its collapsed and extended state. In some embodiments, the locking mechanism 907 is a pin, latch, strap, restraining bar, or gusset that locks in the place in its extended position. In some embodiments, the operator, upon approaching a stairwell or sloped surface, can set the delivery apparatus down and release the extendable handle 905 using the handle locking mechanism 907 to enable it to move to its extended state. The extendible handle 905 provides leverage and control over the apparatus and the secured load, such as when the apparatus is on an uneven surface. Furthermore, the extendable handle 905 provides leverage to remove the user from the load while descending down a sloped surface. Lastly, the extendable handle 905 is long enough to provide a larger lever arm by which the user can apply a force to lift and maneuver the load while on a sloped surface.

FIG. 15 is a perspective view, showing an embodiment of the apparatus' use on a level surface while upright. The delivery apparatus is wheeled about level surfaces on the independent wheels 902. The load is secured on the baseplate 903 using the locking/unlocking mechanism 906.

In a use case shown in FIG. 15 the only moving components are the independently moving wheels 902, which may rotate on separate axles within wheel housings 908. In other embodiments, rotating wheels 902 are on the same axle. In this upright configuration, the user applies a torque about the independently rotating wheels by pulling down and back on the extendible handle 905, which remains rigid relative to the rest of the frame through the locking/unlocking mechanism 907. In an embodiment the unlocking mechanism constrains the extendible handle 905 to a single degree of freedom, such as, but not limited to rotation around a point or sliding along a track. In other non-limiting embodiments, the unlocking mechanism constrains the extendible handle 905 to one or more degrees of freedom. In another non-limiting embodiment, the treads are not moving or engaged in the upright configuration.

FIG. 16 is a perspective view, showing an embodiment of the apparatus being used on an uneven surface such as stairs. Extendible handle 905 is unlocked using the locking/unlocking mechanism 907 and is pivoted to its extended state. In other non-limiting embodiments, the extendible handle 905 slides and/or rotates to its extended state. The extendible handle 905 locks into the extended state shown in FIG. 16 using the locking mechanism described previously. The user then pulls back on the apparatus using the intermediate handle 904 to lower the apparatus to approximately waist height. In one method the user then rolls the apparatus over the first step of the stairwell, holding the intermediate handle 904. The treads 1001 engage the lip of the first stair and enable the apparatus to begin to traverse down the stairs. In one method, the user transitions his grip from the intermediate handle 904 to the extendible handle 905 in its fully extended state. In some embodiments, the extendible handle allows the user to maintain a more ergonomic grip, while providing a longer lever arm on the apparatus to control the apparatus and the fixed load. In a preferred method, the user allows the weight of the load to pull the apparatus down the stairs. In some embodiments the speed of the traversal is controlled using the speed control mechanism 1101.

If the user encounters a temporary level transition, such as a narrow landing between two flights of stairs, the user can transition to the next flight of stairs by using the intermediate handles to provide torque needed to traverse the temporary level surface. In an embodiment, the user will, at the end of the staircase lift the apparatus to its upright state, which allows for a tighter turning radius, using the intermediate handle to gain appropriate leverage. In an embodiment, the user will unlock the extendible handle 905 using the locking/unlocking mechanism 907 to return the extendible handle 905 to its collapsed state. The collapsed state enables the user to move the delivery apparatus in tight spaces while using the extendible handle 905 as the handle for the apparatus in its upright state. This enables the independent wheels 902 to engage on level surfaces to allow the apparatus to rotate with the user on or around tight bends.

In an embodiment, the user will carry or roll the apparatus up stairs using the reverse of the method described. In some embodiments the apparatus assists in moving the load up the stairs using mechanical or electrical devices to provide torque and/or force. In some embodiments the apparatus involves one or more motors, a hydraulic system using energy stored in a pressurized container within the housing 1102, or a mechanical system including springs, flywheels, or other appropriate methods of storing energy.

In one use case shown in FIG. 16 the user rolls the delivery apparatus on the independently rotating wheels 902 while holding the intermediate handle 904 using the method described above until the user reaches the first step of a stairwell. In this scenario, treads 1001 engage the first lip of the first step of the stairwell as the independently rotating wheels 902 move over the first lip. The treads 1001 engage and grip the first lip of the stairs remaining static relative to the step and slide relative to the frame of the delivery apparatus. The user then transitions the grip from the intermediate handle 904 to the extendible handle 905. The user guides the apparatus through force applied at the extendible handle with a mechanical advantage given through the lever arm defined by the length of the extendible handle 905. The treads 1001 contact two, three or more stair lips at any given time providing continuous motion down the stairs. The acceleration of the treads 1001 is limited by the speed control mechanism 1101. The independently rotating wheels 902 act as a bumper for the apparatus as it traverses down the stairs.

Upon reaching a level surface such as a landing on the stairs before a bend, or at the bottom of the stairs, the user applies a force on the extendible handle 905 to disengage treads 1001 from the lips of the stairs as the delivery apparatus pivots around the independently rotating wheels. The user then may change his grip to the intermediate handle 904 and rotate the apparatus on the level surface and drive it further down a flight of stairs using the same method as described above. In another embodiment the user applies a force on the intermediate handle to transition the delivery apparatus to the upright state as described above. The user can then return the extendible handle to its collapsed state through the unlocking of the unlocking/locking mechanism 907. In some embodiments the locking/unlocking mechanism 907 is manual. In other embodiments the locking/unlocking 907 mechanism is automated through electrical, mechanical, or hydraulic methods known to those skilled in the art. In other embodiments the locking/unlocking mechanism 907 is locked and/or unlocked through a combination of manual and automatic methods.

FIG. 17 is an embodiment of the use of the apparatus with an extendible handle 905. The moving components include the independently moving wheels 902. In an upright configuration, the user applies a torque about the independently rotating wheels by pulling down and back on the extendible handle 905, which remains rigid relative to the rest of the frame through the locking/unlocking mechanism 907. In one embodiment the handle locking mechanism 907 constrains the extendible handle 905 to a single degree of freedom, such as, but not limited to rotation around a point or sliding along a track. In other non-limiting embodiments, the handle locking mechanism 907 constrains the extendible handle 905 to one or more degrees of freedom. In one embodiment, the treads are not moving or engaged in the upright configuration.

The extendible handle 905 is unlocked using the handle locking mechanism 907 and is pivoted to its extended state. In other non-limiting embodiments, the extendible handle 905 slides and/or rotates to its extended state, at which point it locks and becomes rigid. The user then pulls back on the apparatus using the intermediate handle 904 to preferably lower the apparatus to approximately waist height. The user then rolls the apparatus over the first step of the stairwell, holding the intermediate handle 904. The treads 1001 engage the lip of the first stair and enable the apparatus to begin to traverse down the stairs. In one method, the user transitions his grip from the intermediate handle 904 to the extendible handle 905 in its fully extended state. In some embodiments, the extendible handle allows the user to maintain a more ergonomic grip, while providing a longer lever arm on the apparatus to control the apparatus and the fixed load. In one method, the user allows the weight of the load to pull the apparatus down the stairs. In some embodiments the speed of the traversal is controlled using the speed control mechanism 1101.

If the user encounters a temporary level transition, such as a narrow landing between two flights of stairs, the user can transition to the next flight of stairs by using the intermediate handle 904 to provide to torque needed to traverse the temporary level surface. In one embodiment, the user will, at the end of the staircase lift the apparatus to its upright state, which allows for a tighter turning radius, using the intermediate handle to gain appropriate leverage. In one embodiment, the user will unlock the extendible handle 905 using the handle locking mechanism 907 to return the extendible handle 905 to its collapsed state. The collapsed state enables the user to move the delivery apparatus in tight spaces while using the extendible handle 905 as the handle for the apparatus in its upright state. This enables the independent wheels 902 to engage on level surfaces to allow the apparatus to rotate with the user on or around tight bends.

In one embodiment, the user will carry or roll the apparatus up stairs using the reverse of the method described. In some embodiments the apparatus assists in moving the load up the stairs using mechanical or electrical devices to provide torque and/or force. In some embodiments the apparatus involves one or more motors, a hydraulic system using energy stored in a pressurized container stored on the apparatus, or a mechanical system including springs, flywheels, or other appropriate methods of storing energy.

In another embodiment the user applies a force on the intermediate handle 904 to transition the delivery apparatus to the upright state. The user can then return the extendible handle 905 to its collapsed state through the unlocking of the handle locking mechanism 907. In some embodiments the handle locking mechanism 907 is manual. In other embodiments the handle locking mechanism 907 is automated through electrical, mechanical, or hydraulic methods known to those skilled in the art. In other embodiments the handle locking mechanism 907 is locked and/or unlocked through a combination of manual and automatic methods.

Certain non-limiting embodiments include a damping mechanism. A non-limiting embodiments used to move heavy loads down stairs include slides or chutes, which provide damping on the loads as they traverse stairs. In some embodiments the slides and chutes are collapsible, allowing for easy storage and quick assembly. Still other non-limiting embodiments include a delivery apparatus that has hydraulic shock absorbers, which work in quick succession to absorb the weight of the load as the apparatus falls from step to step.

FIG. 18 is a profile view, showing an embodiment where the shock absorbers are fluidic dampers 1801. The fluidic dampers 1801 comprise a hydraulic mechanism 1802 and legs 1803. In certain embodiments, the apparatus includes one or more fluidic dampers 1801 to dissipate energy. The fluidic dampers 1801 can include a hydraulic mechanism 1802 that dissipates energy. The fluidic dampers 1801 are tuned to absorb the shock of the apparatus falling from step to step. The legs 1803 of the offset fluidic dampers 1801 can be offset such that when one of the legs 1803 is recovering, the next leg 1803 engages to enable a smooth transition from stair to stair In certain embodiments, the fluidic dampers reduce jarring. In other embodiments, the apparatus includes other types of shock absorbers such as coilover dampers and/or gas dampers. In another non-limiting embodiment heavy loads can be moved down stairs using treads or sled apparatus as described in the embodiments above, without user input. In some embodiments the tread or sled apparatus would have an anchor at the top or bottom of the slope, providing a slowing or damping force to the load. In still other embodiments the sled or tread apparatus would be designed such that it would not require a user, but crawl down the slope in a controlled and automated manner.

Although the above descriptions describe embodiments of the invention, it should be understood that the techniques and concepts are applicable to other delivery systems in general. Thus the invention may be embodied in other specific forms without departing from the spirit or essential characteristics thereof. The embodiments disclosed in the drawings are therefore to be considered illustrative and not restrictive.

While the above describes a particular order of operations performed by a given embodiment of the invention, it should be understood that such order is exemplary, as alternative embodiments may perform the operations in a different order, combine certain operations, overlap certain operations, or the like. References to a given embodiment indicate that the embodiment described may include a particular feature, structure, or characteristic, but every embodiment may not necessarily include the particular feature, structure, or characteristic.

1. An apparatus for transporting objects, the apparatus comprising:
a frame for receiving at least one object;
at least one handle coupled to the frame;
at least one set of wheels coupled to the frame;
at least one track coupled to the frame, wherein the track allows movement of the apparatus in addition to the wheels; and
at least one brake mechanism coupled to the frame.

2. The apparatus of claim 1, wherein the at least one brake mechanism comprises a unidirectional brake.

3. The apparatus of claim 2, wherein the unidirectional brake comprises:
a first unidirectional clutch that allows a first pulley to rotate independently of the first unidirectional clutch in a first direction and prevents the first pulley from rotating independently of the first unidirectional clutch in a second direction; and
a brake that resists movement of the unidirectional clutch.

4. The apparatus of claim 1, wherein the at least one brake mechanism allows variable braking.

5. The apparatus of claim 4, further comprising a control interface for manually adjusting a braking force.

6. The apparatus of claim 4, wherein the at least one brake mechanism is configured to apply at least one preset braking force.

7. The apparatus of claim 6, wherein each preset braking force is calibrated for an anticipated load.

8. The apparatus of claim 7, wherein the anticipated load comprises one keg.

9. The apparatus of claim 7, wherein the anticipated load comprises more than one keg.

10. The apparatus of claim 4, further comprising a controller to automatically adjust the braking force.

11. The apparatus of claim 10, wherein the braking force automatically adjusts based on at least one of a speed of the apparatus, an incline over which the apparatus is traveling, and a weight of the load.

12. The apparatus of claim 1, wherein the at least one brake mechanism applies a braking force between approximately 120 pounds and 160 pounds.

13. The apparatus of claim 1, wherein the at least one brake mechanism applies a braking force of approximately 140 pounds.

14. The apparatus of claim 1, wherein the at least one brake mechanism comprises at least one of a drum brake, a disc brake, a hydraulic disc brake, a levered brake, fluidic dampers, rotational dampers, an eddy-current brake, or a viscous dampener.

15. The apparatus of claim 1, wherein the at least one track comprises a tread assembly.

16. The apparatus of claim 15, wherein the at least one tread assembly comprises:
at least one pulley; and
a tread that rotates around the at least one pulley.

17. The apparatus of claim 16, wherein an inner surface of the tread has a lower coefficient of friction than an outer surface of the tread.

18. The apparatus of claim 16, wherein an inner surface of the tread is cogged.

19. The apparatus of claim 16, wherein:
the at least one pulley comprises a mating groove; and
an inner surface of the tread is a “V” belt that mates with the mating groove.

20. The apparatus of claim 1, wherein the track can be in one of a deployed position and a collapsed position.

21. The apparatus of claim 20, wherein the track comprises a cut channel mechanism to move between a collapsed position and a deployed position.

22. The apparatus of claim 21, wherein the cut channel mechanism comprises a slot to maintain the track in the deployed position.

23. The apparatus of claim 20, further comprising a locking hinge to maintain the track in the deployed position.

24. The apparatus of claim 20, further comprising a track pivot configured to apply a force used to pull the track toward the collapsed position.

25. The apparatus of claim 24, wherein the track pivot comprises at least one of a torsion spring, an extension spring, and a compression spring.

26. The apparatus of claim 20, further comprising a track pivot configured to apply a force resistant to the track being in the collapsed position.

27. The apparatus of claim 26, wherein the track pivot comprises at least one of a torsion spring, an extension spring, and a compression spring.

28. The apparatus of claim 20, further comprising a ratchet configured to allow the track to move toward the deployed position in a first mode of operation and inhibit the track from moving toward the collapsed position in the first mode of operation, and to allow the track to move toward the collapsed position in a second mode of operation and inhibit the track from moving toward the deployed position in the second mode of operation.

29. The apparatus of claim 20, wherein the track can be moved from the collapsed position to the deployed position with a single action.

30. The apparatus of claim 20, further comprising an actuation handle for moving the track from the collapsed position to the deployed position.

31. The apparatus of claim 20, wherein an angle between the track and the frame is less than approximately 45 degrees when the track is in the deployed position.

32. The apparatus of claim 20, wherein an angle between the track and the frame is less than approximately 30 degrees when the track is in the deployed position.

33. The apparatus of claim 20, wherein an angle between the track and the frame is approximately 20 degrees when the track is in the deployed position.

34. The apparatus of claim 1, wherein the tracks are recessed in the frame.

35. The apparatus of claim 1, wherein the tracks are configured to lengthen and shorten.

36. The apparatus of claim 1, comprising a baseplate coupled to the frame, the baseplate configured such that the apparatus can stand substantially upright.

37. The apparatus of claim 1, further comprising a restraining mechanism coupled to the frame.

38. The apparatus of claim 37, wherein the restraining mechanism comprises at least one of a claw, a strap, a restraining bar, and a latch.

39. The apparatus of claim 1, further comprising a second handle, wherein at least one of the first handle and the second handle is modular.

40. The apparatus of claim 39, wherein at least one of the first handle and the second handle is for movement of the apparatus on substantially level surfaces and at least the other of the first handle and the second handle is for movement of the apparatus on substantially sloped surfaces.

41. The apparatus of claim 1, wherein the first handle is configurable to be adjusted in a plurality of positions relative to the frame.

42. The apparatus of claim 41, wherein the first handle can be rotated around a handle pivot.

43. The apparatus of claim 41, wherein the first handle can be extended through a telescoping mechanism.

44. The apparatus of claim 41, wherein the first handle is configured to be adjusted through at least one of manual, hydraulic, mechanical, and electrical actuation.

45. The apparatus of claim 1, wherein the frame is configured for at least one of folding, sliding, and moving the frame to position the first handle.

46. The apparatus of claim 1, wherein the frame comprises an extruded material.

47. The apparatus of claim 46, wherein the extruded material comprises one of aluminum and magnesium.

48. The apparatus of claim 1, wherein the frame comprises an injected material.

49. The apparatus of claim 48, wherein the injected material comprises an injected glass filled with nylon.

50. The apparatus of claim 1, wherein the apparatus is configured to be operated manually.

51. The apparatus of claim 1, wherein the apparatus is configured to be driven through at least manual control.

52. The apparatus of claim 1, wherein the apparatus is configured to be driven through at least one of electronic, hydraulic, and mechanical control.

53. The apparatus of claim 1, wherein the apparatus comprises a driving mechanism configured to increase the speed of the apparatus.

54. The apparatus of claim 53, wherein the driving mechanism comprises a motor.

55. The apparatus of claim 1, wherein the at least one track comprises at least one of a roller, a multi-directional skid bar, a bi-directional skid bar, and a uni-directional skid bar.

56. The apparatus of claim 1, wherein the at least one track comprises a support surface.

57. The apparatus of claim 1, wherein the support surface comprises at least one of aluminum, plastic, and steel.

58. The apparatus of claim 4, wherein the apparatus is configured to determine braking speed based on the acceleration of the apparatus.

59. The apparatus of claim 1, wherein the at least one brake mechanism is located at the at least one of a first end and a second end of the track.

60. The apparatus of claim 1, wherein the at least one brake mechanism provides passive braking.

61. The apparatus of claim 1, wherein the at least one brake mechanism provides active braking.

62. The apparatus of claim 16, wherein the at least one tread assembly comprises a tensioning mechanism, wherein the tensioning mechanism adjusts the tension of the tread between the at least one pulley and a second pulley.

63. The apparatus of claim 62, wherein the tensioning mechanism comprises at least one of a constant force spring, a screw, and a bolt.

64. The apparatus of claim 1, wherein the apparatus is configured to assist in moving the object up stairs.

65. The apparatus of claim 64, further comprising at least one of a mechanical device and an electrical device to provide at least one of torque and force.

66. The apparatus of claim 65, wherein the mechanical or electrical device comprises at least one of a motor, a hydraulic system, and a mechanical system.

67. The apparatus of claim 1, wherein the apparatus is configured to receive at least one keg.

68. The apparatus of claim 1, further comprising a damping mechanism.

69. The apparatus of claim 68, wherein the damping mechanism comprises at least one of a collapsing slide, a chute, a hydraulic shock absorber, a coilover damper, and a gas damper.

70. The apparatus of claim 1, further comprising a first fluidic damper to absorb a shock of the apparatus.

71. The apparatus of claim 70, further comprising a second fluidic damper, wherein the first and second fluidic dampers are offset.

72. A method of transporting an object, the method comprising:
providing a transport apparatus comprising:
a frame for receiving at least one object;
at least one handle coupled to the frame;
at least one set of wheels coupled to the frame;
at least one track coupled to the frame; and
at least one brake mechanism coupled to the frame;
moving the frame on the at least one set of wheels when the frame is on a substantially level surface;
moving the frame on the track when the frame is on a sloped surface; and
utilizing the brake mechanism to decrease the speed of movement of the frame on a sloped surface.

73. The method of claim 72, further comprising adjusting a braking force applied by the brake mechanism.

74. The method of claim 73, wherein the braking force is adjusted manually.

75. The method of claim 73, further comprising applying at least one preset braking force.

76. The method of claim 75, wherein each preset braking force is calibrated for an anticipated load.

77. The method of claim 76, wherein the anticipated load comprises one keg.

78. The method of claim 76, wherein the anticipated load comprises more than one keg.

79. The method of claim 72, further comprising automatically adjusting a braking force.

80. The method of claim 79, wherein the braking force is automatically adjusted based on at least one of a speed of the apparatus, an incline over which the apparatus is traveling, and a weight of the load.

81. The method of claim 72, further comprising using a unidirectional brake to decrease the speed of movement.

82. The method of claim 72, further comprising applying two or more braking forces.

83. The method of claim 72, further comprising applying a braking force between approximately 120 pounds and 160 pounds.

84. The method of claim 83, further comprising applying a braking force of approximately 140 pounds.

85. The method of claim 72, further comprising applying a braking force with at least one of a drum brake, a disc brake, a hydraulic disc brake, a levered brake, fluidic dampers, rotational dampers, an eddy-current brake, or a viscous dampener.

86. The method of claim 72, further comprising rotating a tread around at least one pulley of the track.

87. The method of claim 72, further comprising rotating a tread with an inner surface that has a lower coefficient of friction than its outer surface around at least one pulley of the track.

88. The method of claim 86, further comprising mating a cogged inner surface of the tread with the at least one pulley.

89. The method of claim 86, further comprising mating a “V” belt surface of the tread with the a mating groove of the at least one pulley.

90. The method of claim 72, further comprising deploying the track for use on a sloped surface.

91. The method of claim 90, further comprising securing the track in a deployed position.

92. The method of claim 91, further comprising securing the track in the deployed position using at least one of a cut channel mechanism, a locking hinge, a track pivot, and a ratchet.

93. The method of claim 90, wherein the deploying step is performed with a single action.

94. The method of claim 90, wherein the deploying step is performed using an actuation handle.

95. The method of claim 90, wherein an angle between the track and the frame is less than approximately 45 degrees when the track is in the deployed position.

96. The method of claim 90, wherein the angle between the track and the frame is less than approximately 30 degrees when the track is in the deployed position.

97. The method of claim 90, wherein the angle between the track and the frame is approximately 20 degrees when the track is in the deployed position.

98. The method of claim 72, further comprising collapsing the track.

99. The method of claim 72, further comprising securing the track in a collapsed position.

100. The method of claim 99, further comprising securing the track in the collapsed position using at least one of a cut channel mechanism, a locking hinge, a track pivot, and a ratchet.

101. The method of claim 100, wherein the collapsing step is performed with a single action.

102. The method of claim 98, wherein the collapsing step is performed using an actuation handle.

103. The method of claim 72, further comprising at least one of lengthening or shortening the tracks.

104. The method of claim 72, further providing a track recessed in the frame.

105. The method of claim 72, further comprising restraining the object using a restraining mechanism.

106. The method of claim 105, wherein the restraining mechanism comprises at least one of a claw, a strap, a restraining bar, and a latch.

107. The method of claim 72, further comprising:
providing at least one of a modular first handle and a modular second handle; and
replacing at least one of the first and second handles.

108. The method of claim 72, further comprising the step of extending the first handle by at least one of rotating the first handle around a handle pivot and telescoping the first handle.

109. The method of claim 72, further comprising extending the first handle using at least one of manual, hydraulic, mechanical, and electrical actuation.

110. The method of claim 72, further comprising at least one of folding, sliding, and moving the frame to extend the first handle.

111. The method of claim 72, further comprising operating the transport apparatus manually.

112. The method of claim 72, further comprising driving the transport apparatus through at least one of manual control.

113. The method of claim 61, further comprising driving the transport apparatus through at least one of electronic, hydraulic, and mechanical control.

114. The method of claim 72, further comprising increasing the speed of the transport apparatus.

115. The method of claim 114, further comprising driving the apparatus with a motor.

116. The method of claim 72, further comprising determining the braking force relative to the acceleration of the transport apparatus.

117. The method of claim 72, further comprising using passive braking.

118. The method of claim 72, further comprising using active braking.

119. The method of claim 72, further comprising tensioning the track using a tensioning mechanism.

120. The method of claim 72, further comprising transporting at least one keg.

121. The method of claim 72, wherein the sloped surface comprises stairs.

122. The method of claim 121, further comprising positioning the transport apparatus such that there are at least two points of contact between the track and the stairs.

123. The method of claim 72, further comprising using a damping mechanism to absorb energy.

124. The method of claim 123, wherein the damping mechanism comprises at least one of a collapsing slide, a chute, a hydraulic shock absorber, a coilover damper, and a gas damper.

125. The method of claim 72, further comprising using a first fluidic damper to absorb a shock of the apparatus.

126. The method of claim 125, further comprising using a second fluidic damper, wherein the first and second fluidic dampers are offset.
